(19) United States
(12) Patent Application Publication
(10) Pub. No.: US 2012/0251823 A1
(43) Pub. Date: Oct. 4, 2012

(54) TOW PREPREG AND SYSTEM AND METHOD FOR FORMING THE SAME

(75) Inventors: Freddy Maldonado, Irvine, CA (US); Jesus Fernandez-Marquez, Irvine, CA (US); Atsushi Nohara, Irvine, CA (US); Paul Kyle, Irvine, CA (US)

(73) Assignee: NEWPORT ADHESIVES AND COMPOSITES, INC., Irvine, CA (US)

(21) Appl. No.: 13/439,581

(22) Filed: Apr. 4, 2012

Related U.S. Application Data
(60) Provisional application No. 61/471,644, filed on Apr. 4, 2011.

(51) Int. Cl. B29C 41/30; C09D 133/04; C08K 3/04; C09D 139/04; B29C 41/26; D02G 3/02

(52) U.S. Cl. 428/367; 264/136; 425/71; 428/394; 428/395; 523/468; 524/548; 524/607; 524/589; 524/556

(57) ABSTRACT

The invention provides a tow prepreg having improved productivity and performance. In various embodiments, the tow prepreg has 90% or more resin impregnation and a FAW greater than 600 g/m². A method of making the prepreg by impregnating each continuous reinforcement fiber strand with a thermosetting resin is also disclosed. In various embodiments, the resin is applied to the reinforcement fiber while flattening the fiber between heated rollers positioned in parallel to each other.

### CROSS-REFERENCE TO RELATED APPLICATIONS

This application claims priority to U.S. Provisional Patent Application No. 61/471,644, filed on Apr. 4, 2011, which is incorporated herein in its entirety for all purposes.

### BACKGROUND OF THE INVENTION

1. Field of the Invention

This invention relates, in general, to high performance prepreg, (e.g., either as an individual impregnated fiber, tow or as a unidirectional tape web/sheet) and a novel method for its manufacture. The tow prepreg may be used for diverse applications, e.g., filament winding, fiber placement and other molding methods, while the unitape can be used for the layup of three-dimensional structures, e.g., tubular structures or other complex structural geometries, requiring the use of various angle placement for structural strength and stiffness as a composite structure. This manufacturing method is also suitable for other non-interwoven planes of fibers, e.g., parallel, needed for stiffening large fiber area weight composite structures, for example.

2. Description of Related Art

Fiber-reinforced composite materials are characterized by light weight, high strength, and high rigidity and, therefore, are widely used for the production of sporting goods, large-scale molded bodies such as automobiles and boats, industrial applications such as airplanes and tools, and other products, where the strength to weight ratio advantage of composite materials over metals provides an advantage. A fiber-reinforced composite material may be produced by impregnating (by one of several methods) sheet-shaped fibrous material (either woven or non-woven, continuous, or discontinuous fibers) with a thermosetting matrix resin. This generally is an intermediate material that the part fabricator then manipulates, e.g., by winding or cutting, into various shapes and sizes, subsequently plying them up in various configurations and fiber angles for strength and stiffness, and subsequently submits this structure to heat and cure under pressure to form a cured composite part.

Prepregs are used commonly in the materials industry. Prepreg generally refers to an intermediate material where a reinforcement material is pre-impregnated with resin (b-stage) for later use, such as forming a composite material (article). A uni-directional prepreg is a type or prepreg formed by impregnating a plurality of reinforcement fibers arranged in one direction with a matrix resin. A woven prepreg is another type of prepreg formed by impregnating a woven reinforcement textile fabric with a matrix resin. A multiaxial prepreg can be a combination of both the former and latter, where fibers can be oriented in the X (machine), Y (cross-machine) or Z (perpendicular to the continuous web). Towpreg is an individual strand that is pre-impregnated and supplied in spool form to be used in an automated winding process, to make parts without gaps or seams.

Prepregs have distinct advantages over other composite material forms such as wet layup, pultrusion, and resin transfer by vacuum infusion, because with wet resin, the resin content can vary within the part due to the nature of the process. Furthermore, it is difficult to toughen a wet layup type resin; tougheners usually increase viscosity at the wet process temperature, so it becomes more difficult to impregnate the substrate during a wet layup configuration if tougheners are used.

Existing techniques using standard sheet-shaped prepreg have several general drawbacks. Prepregs from woven or unidirectional prepregs require a high degree of labor to lay the fibers in precise locations, and the resulting structure has joints corresponding to the seams between discrete sheets laid into the molding structure. In addition to being labor-intensive and requiring a high level of skill to manufacture, the seams result in inherent weaknesses in the structure by design so the structure often needs to be made with more layers of material to overcome the weak sections created by these discrete edge seams.

Lately much attention has been drawn to forming a composite from a prepreg having a width substantially similar to that of a single strand or tow as a structural reinforcement, including a wire material for ground anchors and marine applications, and a material for pressure containers. Such a spooled prepreg or towpreg can be used in composite articles where the shape does not lend itself to more conventional techniques such as sheets of prepreg or forming dry fabrics to contoured shapes for wet layup.

As the previous disadvantages of impregnating dry fiber at room temp in a pultrusion or wet-layup approach are less favored for various reasons, one is left with mainly two methods for producing tow-width pre-impregnated fiber: (a) producing a uni-directional prepreg by impregnating a plurality of reinforcement fibers arranged in essentially one direction with a matrix resin and then slitting the essentially uni-directional prepreg to a prescribed width in the longitudinal direction, or (b) directly coating a reinforcement fiber or a small plurality of fibers (e.g., about 2, about 4, about 8, about 16, about 32 or about 64 fibers) with a prescribed amount of a resin for impregnation.

The material produced by the slitting technique is generally referred to as a slit tape. Although it produces excellent accuracy with respect to its width, the resulting slit tape has several problems. The physical properties decline as a result of the continuous fibers being slit into a tow-width tape; there is the continuous breaking or cutting of fibers at the edge part of the slit, so strength is ultimately lost in the strand and ultimately the wound part formed from or comprising the tape. These slit tows may also generate fuzz and other manufacturing defects during part winding, including tow breakage. This slit tow may also need to be supplied with a release liner that has to be removed during an automated winding process, so the opportunity for release of paper slitting debris is also an inherent risk.

A prepreg produced by coating and impregnating a reinforcement fiber with a resin is referred to as a tow prepreg. A tow prepreg is conventionally produced by a solvent lacquer dip/impregnation method wherein a resin is diluted with an organic solvent or solvent blend, a reinforcement fiber is impregnated with the resin, and then the organic solvent is volatilized, leaving a resin-impregnated fiber. However, this method is not environmentally friendly because an organic solvent must be used to achieve impregnation with a moderate viscosity polymer matrix resin (with appropriate toughness and cured Tg requirements) and the organic solvent must then be removed from the tow. Moreover, it is difficult to completely remove the organic solvent and some amount remains in the tow prepreg which can result in a variable tack level in the product. As a result, the remaining organic solvent can volatilize at the time of molding a fiber-reinforced composite material from the prepreg. This can result in air bubbles and voids inside the molded product, which results in a decline in strength and/or appearance. At times, these voids and bubbles are visible as a cosmetic defect. Additionally, residual solvents can outgas during a post production process such as applying a paint or lacquer coat, leaving bubbles or gaps in the finished surface.

“Wet winding” is one method for increasing impregnation. Wet winding involves preparing a low viscosity matrix resin bath at an actual production spot, immersing dry filament fibers in the resin bath, and simultaneously winding. Wet winding has several limitations. First, wet winding is messy and requires a lot of waste handling, so it is not an environmentally-friendly system. Second, the resin system has limits to performance (e.g., toughness and Tg performance). Tougheners generally add to a resin system's viscosity, which make impregnation more difficult at winding process temperatures, thus rendering it less suitable for wet-winding operations. Thirdly, the low viscosity wet resin migrates or flows during winding often resulting in fiber movement during winding, which can result in uneven fiber lengths and fiber tensions, which results in the fiber matrix not bearing the load equally, allowing for the matrix to fail prematurely. Thus, the product usually requires additional winding layers to ensure a minimum structural strength. Finally, wet winding results in varied and inconsistent resin content in the final product, which accordingly results in more variation in final weight strength, stiffness, and performance.

The types of resins useful with wet winding are also limited. The process generally can only be utilized with resin compositions of low viscosity at room temperature. Elevated temperatures usually decrease the working “potlife” (useful lifetime) for the resin mixture and are, therefore, limited for such a process. It is also difficult to strictly control the amount of a resin incorporated in the tow with a wet wind process (final resin content). In order to increase performance of a thermosetting resin, a resin is typically blended with a thermoplastic resin, an elastomer, a rubber component, a filler or the like. However, the viscosity of the resin increases as the mixture incorporates these compositions to improve the final matrix toughness. Accordingly, wet winding becomes impractical as higher composite performance is required. In most cases, the viscosity becomes higher than that of a typical resin composition used in the filament winding method and impregnation thus does not sufficiently occur during the immersion and winding processes. Because the viscosity of usable resins in wet wind processes is limited, the process is generally unsuitable for toughened and/or higher-performance resins. These higher end performance formulations often require the use of heat and hydraulic pressure to impregnate the fiber matrix (hot melt process), or solvent impregnation to impregnate the fiber matrix.

Solvent-based towpregs have the advantage of higher performance, allowing for higher performance resins and the use of various tougheners incorporated into the tow; however, methods not using an organic solvent are very attractive. A method for producing a tow prepreg without using an organic solvent is disclosed by U.S. Pat. No. 3,908,042 to Heissler, et al. Heissler discloses a method for coating a resin on a surface of a kiss roller or contact roller, which is then continuously transferred to one face of a reinforcement fiber by the roller. Specifically, a roller is partially immersed in a heated resin bath and rotated so that a film is coated on the surface of the resin. The thickness of the resin on the surface of the kiss roller and the amount of the resin to be applied to a strand is adjusted by a doctor blade in contact with a roller in the downstream region of a contact point between the resin and the reinforcement fiber strand.

The Heissler system has several drawbacks. Additional heat is required to remove the solvent. The resulting prepreg can exhibit advancement during the solvent removal process and can have varied tack levels as a function of varied resin content. Moreover, the prepregs frequently exhibit within batch or across batch (i.e., batch-to-batch) variations. Excessive solvent remaining in the tow can result in tack variation as well as voids forming during composite cure or during the application of a finish coat such as a clear coat or a painted surface that requires a baking cycle to dry or cure the cosmetic surface coating. Additionally, the viscosity of resins useful in this process must be less than about 20 poise at room temperature. Accordingly, useful resins and their performance ranges are limited.

U.S. Pat. No. 4,211,818 to Ackley proposes a method for immersing a reinforced fiber in a resin bath and then wiping out excess resin from the reinforced fiber. Similar to the Heissler system, the surface of the reinforced fiber can be damaged by the wiping process at several points in the process, and accumulations of broken filaments (balls of fuzz) are generated and accumulate on the surface of the reinforced fiber, and are incorporated into the spool of towpreg. In some cases, these fuzzy bits cause despoiling problems; the resulting breaks in the filaments can split and a portion remains behind on the spool, resulting in several wraps of split fibers accumulating. This can result in increased resistance to despooling, to the point where the tow breaks randomly, and the winding must be discontinued to re-thread the winding machine. This can result in weakened mechanical performance in a towpreg part, in addition to the cosmetic issues resulting from the fuzzy tows.

Japanese Patent Application Laid Open No. S63-162204 (the '204 application) describes a method for producing a tow prepreg by spreading a bundle of continuous fibers to a band state, coating it on a face opposite to a resin band containing no organic solvent with a heating roller and a doctor blade, kneading the resin-coated band to impregnate the fiber with the resin, compressing the resin-impregnated band, and then cooling the band to form the cross-sectional shape. This process, however, tends to generate a significant amount of broken filaments or fuzz balls as previously described, when the widened, reinforced fiber abrades the roller and the doctor roller, thereby preventing continuous production. The system is also relatively complex and requires expensive machinery.

Systems such as Heissler, Ackley, and the '204 application that require a stationary doctor blade or counter-rotating nip rollers have several problems. The doctor blade tends to abrade the material and result in damage, defects, reduced strength, and the potential for continual, ongoing fiber breakage. The mechanical friction of counter-rotating rollers periodically causes fuzzing or breakage of filaments, which can result in cosmetic problems and unspooling problems while wrapping the impregnated tow onto a part. Broken filaments can remain adhered on the spool and the tacky tow can separate. The tacky tow builds up on the roller until it is restrained by the separated tow remaining on the spool and the tow eventually breaks. With the high tensile strength of carbon fibers, this force of resistance can damage equipment if the tow splits and subsequently breaks during winding.

There is a need for improving the performance of composite materials. Conventional methods for forming composite structures generally require balancing resin content with impregnation. Although it is generally desirable to provide a composite with high unit area by weight (FAW) and low resin content (RC), conventional methods are limited to producing carbon fiber film having around 350 grams/m² FAW. At higher FAW, the resulting film structure tends to have a low level of fiber impregnation for several reasons.

Impregnation may be improved by increasing the temperatures, but such temperature increases eventually lead to puckering in the material—because the impregnation is not fully uniform, there can be dry, voided areas that may not lay flat in prepreg form. At higher process temperatures, the material can also react and initiate cure and become higher in viscosity, have shorter remaining product shelf-life, negatively affecting drape and customer processability. Ultimately the fabrication step of part molding may be affected detrimentally as the resin viscosity advances as a result of reaction initiation during initial b-staging of the fiber matrix. Because heat transfer is limited by process temperature and line speed, the higher surface temperatures needed to keep the resin fluid for impregnation can initiate resin adduction with hardener or catalyst. These opposing effects can make a process window extremely small for heavier prepregs, so product consistency or manufactured impregnation quality can suffer greatly as FAW increases. Moreover, large and expensive machinery is required by conventional systems that operate at high temperatures to improve impregnation to offset the tendency to make product at lower speeds and temperatures (low throughput rates=costly product). Relatively high FAW also generally requires undesirable commensurate increases in resin content as one tries to overcome the limitations inherent with high FAW prepregs.

In light of the foregoing, it would be beneficial to have methods and apparatuses which overcome the above and other disadvantages of known prepreg and systems and methods for their production.

It is generally desirable to provide a tow prepreg with good impregnation and performance characteristics. It is generally desirable to provide a prepreg with relatively high drape and low tack so it can be laid up easily and smoothly over a molding surface that can often incorporate curves, and sharp angles. It is accordingly desirable to provide a prepreg having relatively high FAW and low resin content to take advantage of a composite structure that has a lower labor cost (because it is made with fewer heavier weight plys).

### BRIEF SUMMARY OF THE INVENTION

In various embodiments, the invention is generally related to a resin impregnated fiber, a tow prepreg or heavy weight unitape product used for a reinforced composite, its manufacturing method and relevant production equipment. In various respects, the invention relates to a high-performance tow prepreg having 90% or more of resin impregnation. In various embodiments, this tow prepreg is formed by impregnating a continuous reinforcement fiber with a thermosetting resin matrix. Various embodiments of the invention relate to a tow prepreg that is produced economically by impregnating individual continuous reinforced fiber strands with a molten thermoset resin, and the fiber is subsequently chilled before being wound continuously onto a takeup for later use in winding a composite part, or by coating same fibers in a similar manner and accumulating and forming the multiple tows into a continuous heavy Fiber Area Weight (FAW>300 gsm) unitape product. Both product forms are manufactured by a method of the invention and overcome the disadvantages previously mentioned for each product form/type.

In summary, one embodiment of the present invention is directed to a method of producing a tow prepreg by passing a continuous reinforced fiber through a thermoset resin. In various embodiments, the resin is pooled between heated rollers positioned in parallel to each other. In various embodiments, the viscosity of the resin is controlled at between about 0.5 to about 1000 poise. In various embodiments, the reinforced fiber is impregnated with the resin while being molded into an essentially flat shape. The impregnation may be improved by use of contact and/or non-contact heating and cooling. The impregnated fiber is then wound up for delivery.

In various embodiments, molten resin is positioned among a set of parallel heated cylindrical rollers having flat surfaces. A continuous reinforcement fiber may pass through the pool of melted resin such that the melted resin is impregnated into the continuous reinforcement fiber. In various embodiments, the resin-impregnated fiber is simultaneously formed flat in the nip section of the rollers during the impregnation process. In various embodiments, impregnation of the pre-impregnated fiber material is increased by an optional heating process. The heating may be contact heating and/or non-contact heating. In various embodiments, the method includes a cooling process. The cooled prepreg is optionally wound around a core spool by the bobbin without release liner and is supplied in spool form for continuous winding applications.

In various embodiments, the resin viscosity is maintained and controlled in a range from about 0.5 poise to about 1000 poise, e.g., from about 1 to about 500, from about 2 to about 100, from 5 to about 50 poise.

In various embodiments, the system includes at least two parallel rollers on which melted resin is collected, e.g., in a reservoir defined by the surfaces of the rollers. The rollers define a gap there between. In various embodiments where the contact distance with the continuous reinforcement fiber of a first roller (FIG. 1), roller 3 is longer than a second roller (FIG. 1), roller 4, then the ratio of circumferential velocity of the first roller and velocity of reinforcement fiber is between about 0.7 to about 1.2.

In various embodiments, the invention provides improved materials and methods based on an apparatus design which allows for an impregnation set of nip rollers that run the same direction as the fiber to reduce abrasion. Existing coating technologies depend upon counter rotation (against the web or fiber direction), which generates the hydraulic force to impregnate fibers, but also creates frictional forces that accelerate filament damage and associated problems previously described. For roller 3 (FIG. 1), the longer contact roller (wrap), the roller surface speed is best in the ratio from about 0.7 to about 1.2 of the tow or line speed. The minimal contact roller 4 (FIG. 1) can be run stationary to achieve impregnation all the way up to a surface speed of 1.2 times the line speed, depending upon the fiber type, resin melt viscosity, bundle size, sizing type, etc. This roller is less crucial as the gap setting allows for resin lubrication of the tow and thereby reduces friction and fiber damage.

In various embodiments the resin pool is supported by a set of rollers forming a resin dam, capable of maintaining a resin dam for impregnation, the preferred embodiment is a set of parallel horizontal rollers. In an exemplary embodiment, the two rollers are configured essentially horizontally. In exemplary embodiments, more than one set of rollers is utilized. The second and higher order roller sets can also define resin (or other chemical) reservoirs. For example, a second set of rollers can define a reservoir containing a resin of a different chemical composition, different viscosity, different molecular weight, etc., than the material in the first reservoir. In exemplary embodiments, the sets or rollers are disposed in a vertical manner with one set located above another.

In various embodiments, the tow prepreg obtained has 90% or more impregnation with the resin. In various embodiments, the modulus of the reinforcement fiber is about 2500 Mpa or more. In various embodiments, the reinforcement fiber is selected from the group consisting of carbon fiber, carbon graphite fiber, aramid fiber, carbon-silica fiber, boron fiber, tungsten-carbide fiber, alumina fiber, polyethylene fiber, polyester fiber, nylon (polyamide) fiber, steel fiber, polypropylene fiber, E-glass fiber, S-glass fiber, quartz fiber, organic polymer fiber such as PBO (polybenzobisoxazole), polyethylene fiber, and any known precursors and derivatives. In various embodiments, the resin is a thermoset resin with a viscosity between about 100 and about 300,000 poise at about 40° C. In various embodiments, the thermoset resin is selected from the group consisting of epoxy resin, phenolic resin, vinyl-ester resin, unsaturated polyester resin, bismaleimide resin, bt-resin, isocyanate resin, benzoxazine resin, bismaleimide triazine resin, acrylate resin, polyesters, benzoxazines and combinations, precursors, and derivatives of the same.

Another embodiment of the present invention is directed to a system for manufacturing a tow prepreg including two or more rollers for receiving at least one continuous reinforcement fiber therethrough. The two or more rollers are configured to coat the at least one fiber with a flowable resin thereby impregnating the fiber with the resin. The two or more rollers are positioned in a configuration to hold a pool or dam of resin for coating. In various embodiments, the system further includes a heater for heating the reinforcement fiber in the vicinity of the two or more rollers. In various embodiments, the heater is configured to maintain the resin and/or resin-impregnated fiber below a predetermined reaction starting temperature. In various embodiments, the two or more rollers flatten the at least one fiber while coating with resin. In various embodiments, a contact surface of at the two or more rollers are maintained at a predetermined temperature which is a temperature controllable to achieve optimum resin viscosity in order to achieve impregnation of filaments yet not trigger an appreciable advancing reaction or viscosity increase in the polymer melt. In various embodiments, the system further includes one or more chilling rollers downstream from the two or more coating rollers for reducing the temperature of the coated fiber, the one or more chilling rollers maintained at a predetermined temperature.

Yet another aspect of the present invention is directed to a tow prepreg including a tow material formed of a plurality of reinforcement fibers and a resin impregnated in the tow material. The reinforcement fibers are selected from carbon fiber, carbon graphite fiber, aramid fiber, carbon-silica fiber, boron fiber, tungsten-carbide fiber, alumina fiber, polyethylene fiber, polyester fiber, nylon (polyamide) fiber, steel fiber, polypropylene fiber, E-glass fiber, S-glass fiber, quartz fiber, organic polymer fiber such as PBO (polybenzobisoxazole), polyethylene fiber, and any known precursors and derivatives and a resin impregnated in the tow material, resin being a member selected from the group consisting of, but not limited to epoxy resin, phenolic resin, vinyl-ester resin, unsaturated polyester resin, bismaleimide resin, bt-resin, isocyanate resin, benzoxazine resin, bismaleimide triazine resin, bt-resin, acrylate resin, polyesters, benzoxazines, and combinations, precursors, and derivatives of the same; wherein the prepreg has a fiber weight per unit area (FAW) of more than about 250 grams/m² for a unidirectional product or about 150 grams/m² for woven substrates (2 dimensional or multiaxial). In various embodiments, the impregnation ratio of the fiber web with the same impregnation process with the resin is at least 90% impregnated.

The prepregs, systems, and methods of the present invention(s) have other features and advantages which will be apparent from or are set forth in more detail in the accompanying drawings, which are incorporated in and form a part of this specification, and the following Detailed Description of the Invention, which together serve to explain the principles of the present invention(s).

### BRIEF DESCRIPTION OF THE DRAWINGS

FIG. 1 is a schematic view of an exemplary system for producing a prepreg structure in accordance with various aspects of the present invention.

FIG. 2 is a schematic view of an exemplary system similar to the system of FIG. 1, illustrating use of an oven in place of a second set of heated rollers.

FIG. 3 is a plot of viscosity vs. time for the resin Newport NB 301.

### DETAILED DESCRIPTION OF THE INVENTION

Reference will now be made in detail to the various embodiments of the invention, examples of which are illustrated in the accompanying drawings. While the invention will be described in conjunction with the various embodiments, it will be understood that they are not intended to limit the invention to those embodiments. On the contrary, the invention is intended to cover alternatives, modifications and equivalents, which may be included within the spirit and scope of the invention as defined by the appended claims.

For convenience in explanation and accurate definition in the appended claims, the terms “up” and “upper”, “down” and “lower”, “inside” and “outside”, and “downstream” and “upstream” are used to describe features of the present invention with reference to the positions of such features as displayed in the figures.

In many respects the modifications of the various figures resemble those of preceding modifications and the same reference numerals followed by subscripts “a”, “b”, “c”, and “d” designate corresponding parts.

Unless otherwise noted, the terms as used herein are to be understood as generally used in the composites and materials industry and chemical arts.

“Prepreg” is to be understood as generally used in the composites industry. In various respects, “prepreg” generally refers to an intermediate material formed by pre-impregnating a reinforcement material with a resin for subsequent use or processing.

“Impregnating” is to be understood as generally used in the composites and materials industry, and in various respects, refers to saturating or permeating of a material to a functionally sufficient degree. In various respects, “impregnating” refers to at least partially filling interstices in a base material. In various respects, “impregnating” refers to a saturation or impregnation amount selected from at least 35%, at least 50%, at least about 60%, at least about 70%, at least about 80%, at least about 90%, at least about 95%, and at least about 98%. In an exemplary embodiment, the degree of impregnation is assessed visually, for example, by using a microscope. “Impregnating”, “impregnation” and “impregnated” are used herein interchangeably.

“Fiber” refers to fibers, bundles of fibers, filaments, woven fibers, multiaxial constructions, nonwovens, sheets, filaments, and strands of material. As used herein, the singular generally includes the plural and vice versa.

“Resin” is used in accordance with its general meaning in the composite and materials industry and chemical arts. Resin may refer to fibers, melts or particulates of organic resins and synthetic resins such as thermosetting and thermoplastic polymers, composites, and copolymers, precursors, derivatives, and combinations of the same.

“Loosely-coupled” means the elements are positioned or function in relation to one another. In an exemplary process, a plurality of carbon fibers are dispensed in an aligned fashion.

In various respects, “effective amount” generally refers to an amount of polymer to wet-out a material to be impregnated. The effective amount varies depending on process parameters, material specifications, impregnating environment, and other conditions.

“Reaction starting temperature” is to be understood in the context of the materials science and chemical arts. In various respects, “reaction starting temperature” generally refers to the critical temperature at which a thermosetting resin starts to chemically react to a significant degree. In various respects, “reaction starting temperature” generally refers to the critical temperature at which a thermosetting resin starts to catalyze to a significant degree. In various respects, “reaction starting temperature” generally refers to the critical temperature at which a thermosetting resin starts to cure to a significant degree. One will appreciate that the “reaction starting temperature” may vary depending on the reaction environment and other conditions.

“Catalyze to a significant degree” is to be understood in the context of the materials science and chemical arts. In various respects, “catalyze to a significant degree” refers to a level at which the functional or macro-physical characteristics of a thermosetting resin materially and/or permanently changes.

“Controlled” is to be understood as generally used in the manufacturing and materials science arts. In various aspects, “controlled” refers to adjusting a parameter (e.g., viscosity, temperature, speed) to a target value and/or maintaining a parameter within a predetermined range.

By “semi-solid” it is generally meant that the material exhibits some properties of a liquid and a solid. In various respects, “semi-solid” refers to a partially molten or liquid melt material that is capable of flowing or deforming on its own or with pressure or an applied shear stress.

“Relatively high FAW” refers to a weight per unit area (FAW) of about 250 grams/m² or more, and in various embodiments, greater than 400 grams/m², and in various embodiments, greater than 600 grams/m² for unidirectional prepregs. In various embodiments, the FAW is about 150 grams/m² for woven or multiaxial constructions.

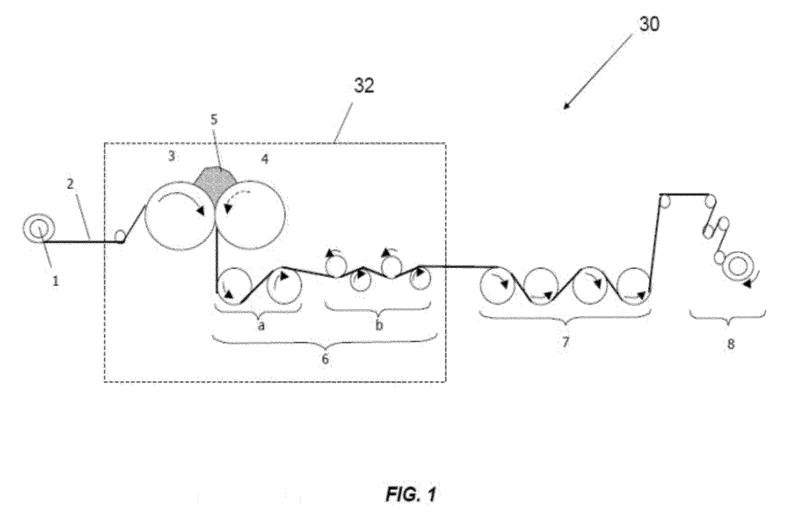

Turning now to the drawings, wherein like components are designated by like reference numerals throughout the various figures, attention is directed to FIG. 1 which illustrates an exemplary system, generally designated 30, for producing an impregnated fiber or tow prepreg in accordance with the invention.

The tow prepreg of the invention may be used for filament winding, fiber placement and other molding methods. In an exemplary embodiment, the edge side of the exemplary tow prepreg is not cut, as it is processed as a single multifilament strand in the novel process. Since the tows are individually impregnated and this towpreg is not a web slit to a custom width the fiber is continuous and will provide higher strength as compared to a sheet of unidirectional prepreg tape slit into individual tows as a means of providing consistent bandwidth. In various embodiments, the tow prepreg is impregnated with a high-viscosity, high performance thermoset resin and has 90% or more impregnation.

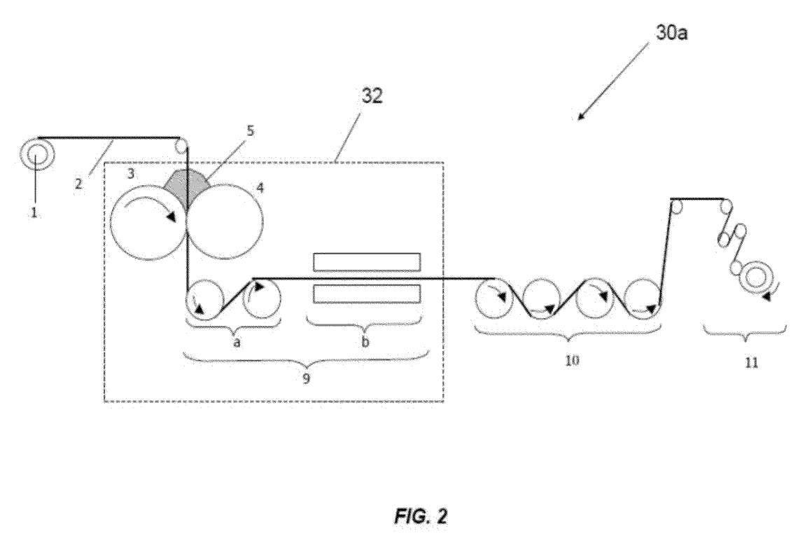

A more complete appreciation of the invention and many of the attendant advantages thereof will be readily understood by reference to the following detailed description when considered in connection with the accompanying drawings, wherein FIG. 1 and FIG. 2 are schematic views showing a device and process for producing a tow prepreg.

As shown in FIG. 1 and FIG. 2, system 30 is configured to produce a high performance tow prepreg having a relatively high resin impregnation. In general, the exemplary system allows for continuous production by passing a reinforcement fiber 2 through a well of thermosetting resin 5 at a resin coating or impregnation station. In various embodiments, the reinforcement fiber is delivered as a plurality of loosely-coupled fibers maintained under tow tension in a flat shape.

In various embodiments, the thermosetting resin 5 is pooled between a set of heating rollers 3 and 4, maintained in a position parallel to each other. While the coating rollers 3 and 4 may be at any angle that supports a resin dam for impregnation. In an exemplary embodiment the angle of disposition of the central axes of the rollers is from about 0° (e.g., horizontal) to an angle of about 45° above the horizon (0°).

In general, the coating rollers 3 and 4 may be any diameter/size ratio to each other. In various embodiments, the ratio is about 1:1 (similarly sized).

The resin viscosity in contact with exemplary rollers 3 and 4 is controlled at about 0.5 to about 1000 poise. In various embodiments, fiber 2 (FIG. 1) is configured as a series of parallel tows and the tows are coated by rollers 3 and 4 in the coating station. The rollers 3 and 4 allow the resin 5 to impregnate fiber 2 while essentially simultaneously giving a flat shape to the reinforcement fiber. Thereafter, the impregnation of the fiber is optionally improved by contact heating and/or non-contact heating. In various embodiments, the impregnated fiber is cooled. In an exemplary embodiment, the impregnated fiber is wound on a spool. This process can also be applied to woven fibers and multiaxial constructions in the same manner. The system and method of operation will be understood from the detailed description below.

With continued reference to FIG. 1, system 30 includes a creel 1 for taking up and feeding a reinforcement fiber or matrix reinforcement 2 to a coating stations. Exemplars of conventional, commercially available creels are disclosed in U.S. Pat. Nos. 5,613,643 to Weiner and 4,082,589 to Patterson et al., the entire contents of which are incorporated herein for all purposes by this reference.

In various embodiments, the fiber is heated in preparation for binding with different materials such as the resin. The system may include a heating station with one or more rollers, at least some of the rollers having a surface at an elevated temperature for heating the material as it is guided by the rollers. One will appreciate that other heating techniques may be used including, but not limited to, devices making use of convection, infrared, and inductive heating to preheat the fiber to eliminate the potential for resin being applied to ambient temperature fiber and therefore interfering with the impregnation process.

The exemplary system includes a guide roller 15 for guiding the material from creel 1 to roller 3. The material is heated between creel 1 and guide roller 15 such that less heat needs to be applied during the impregnation process.

The fiber 2 is transferred from creel 1 and guide roller 15 to coating station 32. In various embodiments, the coating station is positioned close enough to the heating elements such that the fiber material remains at an elevated temperature as it enters the coating process.

Coating station 32 includes impregnation rollers 3 and 4. Although the illustrated exemplary system includes a pair of rollers, one will appreciate from the description herein that the system may include a single roller or a plurality of rollers including, but not limited to, 3, 4, 5, or more rollers.

In various embodiments, the set of impregnation rollers includes at least two rollers positioned adjacent each other and forming a gap therebetween. In an exemplary embodiment, the gap is dimensioned and configured to mold the fiber or fibers and receive resin. In practice, in an exemplary embodiment, the fiber or fibers are molded essentially simultaneously while being impregnated with the resin. In various embodiments, the rollers are positioned in parallel to each other. In various embodiments, the rollers are positioned and configured such that the feed directions are essentially aligned.

One or more impregnation support rollers 6 are provided downstream from the impregnation rollers. The exemplary system includes two sets of impregnation support rollers, generally designated 6a and 6b. The support rollers may be configured for several purposes including supporting material from the impregnation rollers and further processing of the material after initial impregnation with the resin.

System 30 further includes one or more chilling rollers 7 for reducing the temperature of the material downstream from support rollers 6. In the exemplary system, the material is at an elevated temperature in the coating station and the chilling rollers reduce the temperature to a level slightly above room temperature. From the chilling rollers, the material is wound on a winder 8.

FIG. 2 illustrates a system 30a similar to system 30. System 30a includes a creel 1 feeding a fiber 2 to impregnation rollers 3 and 4, a resin 5 applied to the fiber using the impregnation rollers, a plurality of impregnation support rollers 9, chilling rollers 10, and a winder 11. In an exemplary embodiment, chilling rollers 10 are similar to chilling rollers 7, and winder 11 is similar to winder 8. Impregnation support rollers 9 are similar to support rollers 6 except that system 30a includes rollers 9-a and an oven 9-b in place of sets of rollers 6a and 6b. As used herein, the initial impregnation of the reinforcement fiber with resin in the coating station is referred to in various respects as pre-impregnation. In various embodiments, the pre-impregnated material is subjected to subsequent impregnation processing such as secondary heating to improve the impregnation of the final prepreg.

A resin 5 is applied to fiber 2 in the coating station. In the exemplary system, the resin viscosity is controlled. In various embodiments, the resin viscosity is maintained between about 100 poise and 300,000 poise at about 40 degrees Celsius. In the exemplary embodiment, the resin is applied to the fiber as it passes between rollers 3 and 4.

The exemplary resin 5 applied to the reinforcement fiber 2 is in a flowable form. In various embodiments, the resin is one of a solid, semi-solid, liquid, solution or mixture. In various embodiments, resin 5 is a thermosetting resin in semi-sold form. The exemplary resin is a thermoset resin that has been heated above the melt temperature such that it is in flowable form.

In an exemplary embodiment, the resin is a thermosetting resin to which a member selected from the group consisting of an elastomer, a rubber component, a filler, flame retardants, and combinations of the same are added. One skilled in the formulating arts will appreciate from the description herein that other similar materials may be added or changed in ratios to modify the cured composite performance properties.

The fibers 2 that can be used in accordance with the invention are not limited in composition, radial dimension, or length. Suitable materials for fibers 2 include, but are not limited to, carbon fiber, carbon graphite fiber, aramid fiber, carbon-silica fiber, boron fiber, tungsten-carbide fiber, alumina fiber, polyethylene fiber, polyester fiber, nylon (polyamide) fiber, steel fiber, polypropylene fiber, E-glass fiber, S-glass fiber, quartz fiber, organic polymer fiber such as PBO (polybenzobisoxazole), polyethylene fiber, and any known precursors and derivatives. Combinations of organic, mineral or metallic fibers or filaments are also possible. In various embodiments, the tow prepreg and system make use of a reinforcement fiber selected from E-glass fiber, S-glass fiber, quartz fiber, ceramic fiber, aramid fiber, carbon fiber, and carbon graphite fiber.

In various embodiments, fiber 2 is selected to achieve a resulting prepreg product with a particular tensile modulus and/or reduced weight. In various embodiments, the reinforcement fiber before impregnation has a tensile strength of about 2500 MPa or more. In various embodiments, the reinforcement fiber has a tensile modulus of about 3000 MPa or more. In an exemplary embodiment such fibers are those presented previously including, but not limited to, fiber bundles from 1 k up to 100 k (1 k=1,000 filaments per strand).

Suitable materials for resin 5 include, but are not limited to, epoxy resin, phenolic resin, vinyl-ester resin, unsaturated polyester resin, bismaleimide resin, bt-resin, isocyanate resin, benzoxazine resin, bismaleimide triazine resin, acrylate resin, polyesters, benzoxazines, and combinations, precursors, and derivatives of the same. In some cases, handling nature and mechanical properties of the material may be given close consideration. For example, epoxy resin, bismaleimide resin, bt-resin and isocyanate resin may be preferable in some applications because these resins can be pasted up strongly. Epoxy resin may be suitable for applications where chemical resistance, high mechanical performance, and cost are important factors.

A variety of epoxy resins may be used in accordance with the invention. Epoxy resins with two epoxy functions (epoxide group) in a molecule may be used. Exemplary resins include bisphenol A-type epoxy resins, bisphenol F-type epoxy resins, bisphenol S-type epoxy resins and brominated epoxy resins, alkyl type epoxy resins, biphenyl type epoxy resins, naphthalene type epoxy resins, and dicyclo-pentadiene type epoxy resins. Epoxy resins having oxazolidone structures, its derivative epoxy resins, and/or brominated epoxy resins may also be used. Epoxy resins having three or more epoxy functions (epoxide group) in a molecule may be used. Exemplary resins include phenol-novolac type epoxy resins, cresol type epoxy resins, glycidyl amine resins (e.g. tetra-glycidyl-di-amino-diphenyl-methane, tri-glycidyl-amino-phenol, tetra-glycidyl-amine, etc), glycidyl ether type epoxy resin, tetra-bis-(glycidyl oxyphenyl)-ethanol, tris-(glycidyl-oxy-methanol), and its derivatives and/or brominated forms of the same.

In various embodiments, a curing agent is provided in the resin solution or added downstream from pre-impregnation of the fiber with the resin matrix. In various embodiments, a hardening agent is added to the epoxy resin. Suitable hardeners include, but are not limited to an amine curing agent and acid curing agent. Exemplars of an amine curing agent include dicyandiamide, an imidazole, an aliphatic amine, a urea, an aromatic amine, an anhydride, and isomers thereof. Exemplars of an acid curing agent include an acid anhydride curing agent, a phenol curing acid, and a Lewis acid. These agents for curing the epoxy resin may be used in applications requiring high mechanical performance and productivity. In an exemplary embodiment a curing agent is maintained in a well between two rollers similar to the set up for the resin. The second set of rollers is optionally arranged vertically beneath the impregnation rollers.

In various embodiments, additives or agents are added to the resin to improve performance. For example, the addition of the additives may result in a relatively higher viscosity. Thus, resins having a low viscosity in unaltered form may be altered for use in the system. In this manner, the process of the invention enables use of a broader range of resins than can be used in a filament winding process. Specifically, the process enables expansion of the resin viscosity range of applicable thermosetting resins to a range between about 0.5 to about 1000 poise, e.g., from about 1 to about 500, from about 2 to about 100, from 5 to about 50 poise. By contrast, conventional winding processes can not use high-performance resins because of the low viscosities required. Moreover, one will appreciate that conventional winding processes involving a single dipping step can not be modified easily to accommodate additives in the manner described herein. As a result, a tow prepreg obtained by the process of this invention allows production of fiber-reinforced composite materials having excellent mechanical strength. In various embodiments, one or more kinds of additives or agents are added to the resin to improve performance.

Suitable additives include, but are not limited to, inorganic fillers (e.g. silica powder), an elastomer, an agent used to dye or color the resin, flame retardant agents (e.g. hydration aluminum, a brominated compound, and a phosphorous compound), and defoaming agents. Suitable elastomer additives include, but are not limited to, butyl rubber, isoprene rubber, nitrile rubber, silicone rubber, a caoutchouc (natural rubber), India rubber, and combinations of the same.

In various embodiments, one or more thermoplastic resins is dissolved or blended in the thermosetting resin. As mentioned above, the resin may be in solution or mixture form. Suitable thermoplastic additives include, but are not limited to, a polyaramid, a polyester, a polyoxymethylene, a polycarbonate, a, polyvinylformal, a polyvinylformaloxide, a polyphenylenesulfide, a polyimide, a polyetherimide, a polysulfone, a polyamide, a polyamideimide, a polyetheretherketone, a polyethersulfone, and combinations or derivatives of the same.

The method of making a tow prepreg in accordance with the present invention will now be described with reference to FIGS. 1 and 2. Fiber 2 is driven by rollers 3 and 4. At least one of a pair of the exemplary rollers is optionally disposed in parallel to each other.

In an exemplary embodiment, a pair of rollers is driven in the direction of fiber travel through the gap defined by the rollers. One will appreciate, however, that the positioning and rotation of the rollers may be altered depending on the application. By example, in some cases it may be desirable to adjust the direction rotation or velocity to increase or decrease abrasion, pressure, or tension on the fiber. In some cases, it may be desirable to adjust the rotational velocity and direction to reduce wear and tear on the equipment. In an exemplary system, if neither the roller 3 nor the roller 4 is driven, large friction forces may occur when reinforcement fiber 2 passes through the gap. As a result, the reinforcement fiber may be damaged such that reproducible production of a strong material is not possible.

In FIG. 1, the reinforcement fiber is brought into contact with rollers 3 and 4, then rollers 6 followed by chilling rollers 7. In FIG. 2, the impregnated fiber is brought into contact with one of a pair of rollers 10 disposed in parallel to each other. In operation, the circumferential velocity of roller 3 (otherwise referred to as roller surface velocity) in the exemplary system of FIG. 1 is between about 0.7 to about 1.2 times the moving velocity of the reinforcement fiber (hereinafter referred to as line speed or “production velocity”), preferably between about 0.8 to about 1.1 times the production velocity, and more preferably between about 0.9 to about 1.05 times the production velocity.

The circumferential velocity ratio is calculated by the velocity of roller 4 divided by the velocity of roller 3. The circumferential velocity of a roller essentially defines the velocity of a roller surface rotation, much like line speed. If the circumferential velocity of the roller is too low, in relation to the fiber speed, large frictional forces may result between the roller and the reinforcement fiber during production. Consequently, a large amount of fluff or fiber fuzz is generated during the production, resulting in the generation of many fluffy balls of abraded fiber and the possible breaking of the reinforcement fiber. If the circumferential velocity of the roller is too high, tensile force declines at the take-up part because the reinforcement fiber is sent faster than the production velocity. As a result, the reinforcement fiber is loosened or slackened during the process. Without other modifications, this can make long-term continuous production more difficult.

In the case of FIG. 1, the roller 4 optionally remains stationary and can be less likely to have abrasion forces like with roller 3. In an exemplary embodiment, roller 4 is rotated within a circumferential velocity ratio range of between 0 and about 0.5 with respect to the rotational speed of roller 3. If the velocity of roller 4 is far outside of this range, a thermosetting resin may be extruded through the gap in sync with the rotation of roller 4 and it may become difficult to control the resin content of the fiber or tow prepreg. In various embodiments, exemplary rollers 3 and 4 rotate at adjustable speeds to accommodate the different fiber thicknesses, gaps and needed resin contents. One skilled in the manufacturing engineering arts will appreciate, however, that the mechanisms for applying the resin, and the impregnation process itself, may be modified depending on the application requirements as described above. For example, the circumferential velocity of the rollers, production velocity, and other parameters may be adjusted depending on the desired resulting product resin content, a different resin content may require a different rotational speed for more precise control of the final resin content, depending upon the gap and production line speeds used. Various process melt viscosities of different formulation requirements may result in different hydraulic pressure effects which may result in the need for adjustments to the relative roller speed ratios to the line speed and to each other as a best final product quality practice.

One will appreciate that the spacing and configuration of fibers 2 prior to being set by matrix resin 5 may vary. The fibers may be positioned with a set spacing therebetween or positioned directly adjacent to each other. In various embodiments, the fibers are fixed using a comb or the like before introducing them to impregnation rollers 3 and 4 so that the fibers do not pile up or cross-over on each other.

The impregnation process, in general, may be controlled in a number of ways. Besides the material properties, the application of the adhesive resin to the substrate is generally affected by the adhesive resin flow, pressure, temperature, presence of catalysts, and other parameters. Some of these parameters may be controlled by rollers 3 and 4. Exemplary coating station 32 includes dispenser nozzles to deliver flowable, liquid resin 5 to the rollers. The resin is provided from a tank, and the system optionally includes a guide for guiding the resin from the tank to the rollers. The guide may be configured to apply tension to the resin and/or reinforcement fiber.

In various embodiments, the resin is applied to the reinforcement fiber under effective conditions and in an effective amount to impregnate the reinforcement fiber thus forming an intermediate prepreg 33. Impregnation is optionally subsequently improved by application of heat as described such that the resin further impregnates the reinforcement fiber.

Resin 5 may be applied to reinforcement fiber 2 in a number of ways. The rotating rollers 3 and 4 may have a portion of or their entire peripheral surfaces covered with the resin material. The resin may be prepared on a mandrel in a conventional manner before application to the substrate. In various embodiments, a release-type chemical agent is provided on the roller surface. In various embodiments, rollers 3 and 4 “wet” out reinforcement fiber 2 to enable attaching further materials.

In the exemplary system, one or more dispensers having nozzles receive the resin from a resin reservoir tank and control the flow of the resin to rollers 3 and 4. The nozzles control the flow rate and volume of resin. The amount of resin on the rollers may also be controlled by the circumferential velocity of the rollers. An effective tension may be controlled by adjusting the relative feed rates of the rollers. Tension may also be controlled using a resin guide. The guide may also be provided to control the position where the resin is applied to rollers 3 and 4.

One will appreciate from the description herein that the other parameters of the creel, impregnation rollers, support rollers, and other components alone or in combination may be adjusted to achieve a desired effect.

### Adjustment of Impregnation Temperature

In an exemplary system, rollers 3 and 4 are heated. The temperature of the reinforcement fiber from creel 1 to winder 8 may also be adjusted and controlled within predetermined ranges in an exemplary system. The temperature of the rollers may be controlled using external or built-in heaters or by a thermal medium circulating method. One will appreciate that other heating techniques may be employed. For example, induction heating type rollers capable of automatically heating may be used.

In various embodiments, the temperature of heated rollers 3 and 4 in the coating station is one at which the viscosity of the matrix resin is between about 0.5 to about 1000 poise, more preferably one at which the viscosity of the matrix resin is between about 1 and about 800 poise, more preferably one at which the viscosity of the matrix resin is between about 10 to about 500 poise. In various embodiments, the matrix resin has a viscosity of from about 1 to about 500, from about 2 to about 100, or from 5 to about 50 poise.

Within the above viscosity ranges, the matrix resin tends to be semi-solid and act as a lubricant to help the fiber form flat at the same time that the fiber is impregnated with the matrix within rollers 3 and 4. This provides a mechanism to prevent damage to the fiber caused by abrasion at the time of its passing through the rollers. If the viscosity of the matrix resin is too low, the matrix resin may flow out of the gap of the parallel rollers, whereby the matrix resin cannot be pooled between a pair of the rollers. In addition, the fiber may be damaged by abrasion because the lubricating effect, mitigating abrasion between the reinforcement fiber and the rollers, is lost. If the viscosity of the matrix resin is too high, significant frictional force occurs when the fiber attached with resin passes through the gap. As a result, the fiber may be damaged. Similarly, the rollers disposed in parallel to each other may become misaligned due to the friction force whereby it becomes difficult, if not impossible, to stably control the amount of the matrix resin to be impregnated in the reinforcement fiber. A large degree of friction may also increase wear on the equipment. Thus, selection of the appropriate resin viscosity is an important factor.

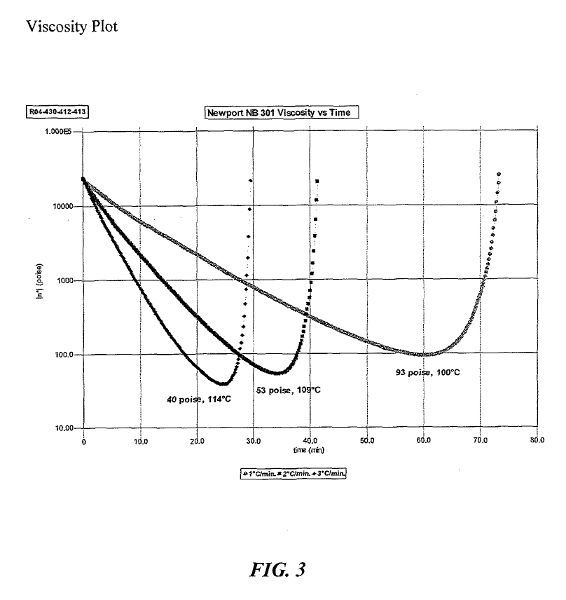

The temperature for controlling the viscosity of matrix resin 5 may be found based on a predetermined temperature viscosity curve of the thermosetting resin. See, e.g., FIG. 3. This temperature viscosity curve can be found by measuring the temperature within a required temperature range by commonly used tools such as a B, SV or E type viscometer, or the like. Accurate values may be found by measuring viscosity at given temperature intervals while raising temperature using a commercially available viscoelastic measuring instrument. In the exemplary embodiment, predetermined temperature viscosity was found using a TA Instruments AR2000 and a 25 mmφ parallel plate rheometer at an oscillation frequency of 1 Hz (1 oscillation/sec) under with temperature rising at a rate of 2° C. per minute. (ASTM D4440-08). Other means may employ a rotation of 10 radians/second such as per SACMA method SRM 19-94.

In various embodiments, the temperature in an exemplary coating station system is tightly controlled to ±2° C. or less to achieve a desired intermediate material. The reaction of a thermosetting resin generally starts at a given temperature referred to herein as the “reaction starting temperature.” Since viscosity is correlated to temperature, the viscosity of a resin increases as the temperature rises. In various embodiments, the production and pre-impregnation temperature is lower than the reaction starting temperature. By maintaining the temperature and other conditions to avoid allowing the resin to catalyze to a large degree, the process of the invention allows use of a wider variety of resins including those with a relatively high stated viscosity.

In various embodiments, the resin is contacted with the fiber under conditions effective to cause at least partial impregnation without causing the intermediate fiber or prepreg to plasticize or significantly lose its drape. In various embodiments, the resin is contacted with the reinforcement fiber under sufficient conditions to cause at least partial impregnation without causing the resin or fiber to catalyze to a significant degree. In general, the fibers and/or resin are heated to promote impregnation but are kept at a temperature below the reaction starting temperature or temperature at which one or both materials will undergo undesirable chemical and property changes. In various embodiments, the resin and/or fiber is heated above a melt temperature but below a chemically-active temperature at which the materials undergo a chemical change the reaction starting temperature.

The exemplary system optionally includes a heating station to subject the pre-impregnated prepreg to further heating. The secondary heating serves to improve the impregnation ratio while avoiding excessive temperatures that can cause the resin and/or fiber to catalyze. The secondary heating station may apply heat by contact or non-contact means. In various embodiments, the heating conditions are selected accordingly provided that temperature and heating time are such that the thermosetting resin is not catalyzed or fully cured, yet allowing a near-complete impregnation of the filament bundle to preserve the columnarization of the fibers in prepreg form and to prevent further damage. The higher level of impregnation also improves drapability and allows part winding or layup with less entrapped air which can also negatively affect cured composite properties.

In the case of non-contact heating, a hot wind oven (e.g., element 9b in FIG. 2) may be employed. In the exemplary system of FIG. 2, the oven has a temperature lower than the curing temperature of thermosetting resin 5. The temperature of the non-contact heating element and the heating time can be appropriately set depending on the type of resin and the type of reinforcement fiber among other factors.

### Adjustment of Resin Content

The amount of resin to be impregnated into a reinforced resin can be adjusted by the gap between the rollers 3 and 4 in FIG. 1. At least one of a pair of the rollers 3 and 4 disposed in parallel to each other in FIG. 1 can be slid away from the other, thus adjusting the gap between the rollers (referred hereinafter as to the “gap”). One can appreciate that the gap controls the amount of resin applied to the fiber and the gap ideally is adjustable to accommodate different size tows for impregnation. Known equipment may be provided to increase or decrease the gap by micrometer (or other) increments in order to adjust the content of a matrix resin to be impregnated in the tow prepreg. The mechanism of adjustment is not particularly limited, however. For example, suitable mechanisms include a cotter system for making an adjustment by sliding a trapezoid-shaped slide and placement of a precision cylinder or a clearance gauge in the gap.

The optimal value of the gap between rollers 3 and 4 in FIG. 1 generally will vary depending on the desired resin content, the type of reinforcement fiber to be used, the thickness and shape of the reinforcement fiber, the type of resin, and other parameters. In various embodiments, the gap is set to obtain a desired tow prepreg.

Although the gap width may be adjusted to dispense resin at a wide range of flow rates, thereby achieving a correspondingly large range of resin content in the resulting product, it may be difficult to achieve especially low or especially high resin content by adjustment of the gap width alone. If the product has a relatively low resin content, for example less than about 20%, the gap to be set between the impregnation rollers may be very small compared with the thickness of tow. As a result, the matrix resin may not function as a lubricant and the reinforcement fiber may be damaged by abrasion with the rollers. In various embodiments, the desired resin content of the manufactured product is selected to be sufficiently high to achieve stable production for an extended period of time. On the contrary, if the product has a relative high resin content, for example greater than 50%, it becomes increasingly difficult to tightly control the resin content because the resin content starts to exceed the amount that can be contained in a reinforcement fiber. Moreover, large gap widths corresponding to high resin contents make it difficult to accurately control the flow of resin between the rollers.

In various embodiments, the desired resin content is between about 20% and about 50%, preferably between about 20% and about 45%, more preferably between about 25% and about 40%, and more preferably between about 28% and about 35% by volume. A preferred embodiment is one in which the resin content supports common ranges of suitable resin vs. fiber volume ratios for optimal composite matrix strength and performance with respect to the resins and fibers set forth herein.

In order to achieve a higher resin content in and/or impregnation of the fibers, in the exemplary embodiment the intermediate tow prepreg 33 impregnated with resin 5 by rollers 3 and 4 is subsequently subjected to contact heating and/or non-contact heating. The resulting product, generally referred to as tow prepreg 33, thus may achieve a high impregnation. The level of impregnation achieved may be greater than 90%, preferably greater than 95%. The optimal method and temperature typically vary depending on the resin type, the reinforcement fiber type, and production velocity among other factors.

In various embodiments, the temperature during initial impregnation at rollers 3 and 4 is lower than the starting reaction temperature. In various embodiments, the temperature during subsequent heating is lower than the starting reaction temperature. In an exemplary embodiment, the parameters of the impregnation process, including optional heating and further processing to increase impregnation, are selected and controlled to avoid or minimize the onset of catalyzation and/or curing.

In the exemplary case of contact heating of FIG. 1, rollers 6-a are smooth-surfaced rollers with a large surface area. If a grooved roller is used, the number of applicable reinforcement fibers will be limited and the productivity may decline without corresponding process changes. By flattening reinforcement fiber 2 simultaneously, or nearly simultaneously, with the resin impregnation process, the process of the invention is able to yield a high performance prepreg with high impregnation and similar dimensions to a tow composite. The resulting flat tow is more uniformly impregnated to a consistent resin content, and as a flat tow, winds more uniformly to provide void-free parts

The width and dimensions of the tow prepreg may be controlled as is appreciated by one of skill from the description herein. For example, if one wishes to control the width of the resulting tow prepreg, grooved rollers may be used as guide rollers 6-b in FIG. 1. In this case, an angle between reinforcement fiber 2 and the roller may be between about 1° and about 30°. If the angle is significantly greater than 30°, the tensile force of tow may increase to the point where the reinforcement fiber is damaged. If it is significantly less than 1°, it may be difficult to control the width of the tow.

### Cooling and Take-Off

In various embodiments, a cooling station is provided downstream from the coating station and optional heating elements. In various embodiments, the system includes a take-off roller capable of cooling the tow prepreg impregnated with the thermosetting resin to room temperature. The exemplary system 30 includes chilling rollers 7 disposed between the coating station and winder for cooling the prepreg. One will appreciate that other mechanisms may be employed to accomplish both cooling and take off. In one example, the material is cooled by circulating a heat transfer medium (e.g., water) inside the chilling rollers. In another example, lower temperature air or another fluid is circulated across the material and/or the rollers.

The cooled prepreg is transferred to winder 8. In the exemplary system, the winder includes a bobbin. The tow prepreg may be taken up to the bobbin by a “guide traverse winder” in which a guide traverses in the axial direction of the bobbin or by a “bobbin traverse winder” in which the bobbin traverses in the axial direction. One will appreciate that other mechanisms for storing and/or finishing the prepreg product may be provided.

The exemplary prepreg prepared by the system of FIG. 1 has several advantages over conventional systems and products. The prepreg has good performance characteristics yet can still be molded, shaped, and otherwise manufactured by the end user. In comparison to conventional processes, the resulting product has an improved impregnation rate, relatively high FAW, and improved drape and tackiness.

The exemplary process results in a tow prepreg having a FAW of about 250 grams/m² or more, and in various embodiments, greater than about 400 grams/m², and in even further embodiments, greater than 600 grams/m². The exemplary process achieves a relatively low resin content. In some cases, the resulting tow prepreg has a resin content below about 35% by weight. In various embodiments, the resin content of the resulting tow prepreg is below about 30%, preferably below about 25%, more preferably below about 20% by weight.

The invention provides a high performance tow prepreg. The impregnated reinforced fibers do not have many of the disadvantages of art-standard prepregs, and in particular tow prepregs, produced using conventional systems. Since the fiber travels in the same direction as the circumferential motion of the coating roller, there is less friction imparted to the fibers during impregnation compared with traditional resin shear created by counter-rotating nip rollers or through stationary rollers or blades.

An exemplary system generally is a hot melt system. The system thus achieves a higher degree of formulating latitude than is achievable with a wet wind system. Higher performance resins and tougheners can be employed in the present process compared to a wet-wind process.

An exemplary system and process is generally solventless. The good tack of the final product is achieved more consistently through formulation and is not influenced by the degree of drying or a residual solvent left in the tow as with a solvent impregnation process. The degree of formulation latitude that exists with woven hot melt and unidirectional sheets is readily employable with the system and process of the invention. Additionally, there are no residual solvents that may outgas to form voids during heating and cure.

Since the exemplary hot melt resin is semi-solid, it does not migrate during winding as would a resin of use with wet wind. Fiber placement is therefore more precise and it does not change as in wet winding where the outer wraps often squeeze wet resin to the surface of the wound part leaving the inner fibers untensioned due to the pressure of the outer wraps extruding the resin to the surface. With tow prepeg therefore, resin content is, therefore, more uniform throughout the part and fiber tension is maintained through the part as a result.

The exemplary tows are individually impregnated rather than formed as a sheet and cut into narrow tows. Thus, the filaments are continuous and deliver the ultimate strength properties to the composite. Without cut edges, there is much less risk for the impregnated fiber to stay behind on the spool and result in bandwith control problems. As a continuous strand, strength is also optimized over a slit tape.

Compared with conventional hot melt impregnated strands, an exemplary system and process of the invention includes process rollers positioned in parallel. One will appreciate that with the system and process of the invention there is less chance for broken filaments, fuzz or tow breakage during winding operations in comparison to counter-rotating, abrasive rollers.

The tow prepreg of the invention is suitable for many uses including, but not limited to, filament winding, fiber placement, and other molding methods. The product exhibits superior performance edge-side. Since the tows are individually impregnated and the tow prepreg is not a slit web, the reinforcement fiber is continuous and will provide higher strength as compared to tows that are individually slit as a means of providing consistent bandwidth.

Similar to prepreg, where high performance thermoset resin is made to impregnate continuous reinforcing fiber, the invention provides a tow prepreg impregnated with high performance thermoset resin. In various respects, the prepreg tow has 90% or more impregnation.

The invention is further illustrated by the Examples that follow. The Examples are not intended to define or limit the scope of the invention.

### EXAMPLES

### General Considerations

The invention is further illustrated by the Examples that follow. The Examples are not intended to define or limit the scope of the invention.

The properties for the examples and comparisons below were obtained by the following techniques.

The manufactured tow prepreg was cut to a length of 10 feet (3048 mm) and the weight (W1) was measured. The tow prepreg was washed with 100 cc of methyl ethyl ketone three times and its dry weight (W2) was measured. The resin content was calculated by the following Formula 2. A mean value of ten measurements was determined.

RC(%)=(W1−W2)/W1*100 (2),

where RC is resin content and W is weight.

A photo of the cross-section of the tow prepreg was taken using a microscope (VHX-100) manufactured by Keyence Corporation, and the ratio of an area of impregnated portions to an area of unimpregnated portions calculated to determine the resin impregnation ratio according to Mathematical Formula 3.

Resin impregnation ratio=area of impregnated portions/entire cross-section area of a tow prepreg*100 (3)

The criteria for determining the material windability are as follows. A tow prepreg was taken up by a bobbin on a creel and unwound at a speed of 100 feet per minute at room temperature. Windability was judged “good” when the prepreg could be continuously unwound. It was judged “poor” when the tow prepreg was broken by fuzz, broken filaments, or ringers at the time of unwinding.

The criteria for determining tackiness were as follows. Two tow prepregs were crossed orthogonally at 23° Celsius at 50% relative humidity (RH) and then pressed against each other for five minutes by force of 10 g.

Afterwards, tackiness was judged “good” if the tow prepregs were stuck to each other and resisted peeling apart. Otherwise, the prepreg was judged to have “poor” tackiness.

The method for determining 90° tensile strength was as follows. The tow prepregs obtained were placed on exfoliate or release paper by a drum winding method in preparation for forming uni-directional prepregs. After laminating the prepregs, the prepregs were cured at 250° Fahrenheit for 2 hours to obtain a uni-directional reinforced fiber composite material having a thickness of 2 mm. The tensile strength of the material was measured in accordance with ASTM D 3039.

### Example 1

The prepreg was formed using a system set up according to FIGS. 1 and 2. Four carbon fibers (HR40 manufactured by Mitsubishi Rayon Co., Ltd.) at 1 inch intervals were used as a starting material. Parallel rollers 7 and 10 as shown in FIGS. 1 and 2 were maintained at 80° C. An NB317 resin (Newport Adhesives and Composites Corporation) was heated to approximately the same temperature.

After maintaining the viscosity of the resin at 16.1 poise, the resin was introduced into the gap between the impregnation rollers. The impregnation rollers were maintained at 70° C. and the roller feeding the resin (e.g., 5) was maintained at 15° C. The gap between rollers 3 and 4 was 3 mils (0.003 inch).

A tow prepreg was produced at a speed of 30 feet per minute. The circumferential velocity of the roller “a” in FIG. 1 was 30 feet per minute, and the circumferential velocity of the roller “b” was 1 foot per minute.

The results of the Example 1 run are shown in Table 1. The resin content of the tow prepreg thus obtained was 31.5%. The resin impregnation ratio was 98% based on the photographic observation of the cross-section of the tow prepreg. An unwinding test was conducted and it was found that no ringers were generated at the time of unwinding. The tow prepreg could be unwound very well. A 90° tensile strength test was conducted and found a good value (65 MPa).

### Example 2

The prepreg was formed using a system and method similar to that of Example 1 except that the temperature between the parallel rollers 7 and 10 was 78° C., the gap between the rollers was 4 mil instead of 3 mil, the production velocity was 35 feet per minute, and the temperature of the impregnation rollers 3 and 4 was 98° C.

The results of the Example 2 run are shown in Table 1. The resin content of the tow prepreg was 35.9%. The resin impregnation ratio was 98.3% based on the photographic observation of the cross-section of the tow prepreg. The results of the tackiness, unwinding, and 90° tensile strength tests were good as shown in Table 1.

### Example 3

The prepreg was formed using a system and method similar to that of Example 1 except that the temperature between the parallel rollers 7 and 10 was 78° C., the gap was 5.25 mil., the production velocity was 45 feet per minute, and the temperature of the impregnation rollers was 97° C.

The results of the Example 3 run are shown in Table 1. The resin content of the tow prepreg was 32.1%. The resin impregnation ratio was 97.5% based on the photographic observation of the cross-section of the tow prepreg. The results of the tackiness, unwinding, and 90° tensile strength tests were good as shown in Table 1.

### Example 4

The prepreg was formed using a system set up according to FIG. 2. Four carbon fibers TRH50 60K (Mitsubishi Rayon Co., Ltd.) at 25.4 mm intervals were used as a starting material. Parallel rollers 3 and 4 as shown in FIG. 2 were heated to 75° C. A SC301 resin (Newport Adhesives and Composites Corporation) was also heated to the same temperature.

After maintaining the viscosity of the resin at 14.7 poise, the resin was introduced into the gap between the impregnation rollers. The rollers 9a and 9b in FIG. 2 were adjusted to 75° C. and the rollers 10 was maintained at 15° C.

The gap between the rollers 3 and 4 was 4 mil. A tow prepreg was produced at a speed of 35 feet per minute. The circumferential velocity of the roller 3 and 9a was 34 feet per minute and the rotation of the roller 4 was zero.

The results of the Example 4 run are shown in Table 1. The resin content of the tow prepreg thus obtained was 30.2%. The resin impregnation ratio was 95.8% based on the photographic observation of the cross-section of the tow prepreg. The results of the tackiness, unwinding, and 90° tensile strength tests were good as shown in Table 1.

### Examples 5-10

The prepreg was formed using a system set up according to FIGS. 1 and 2. Several runs were made to produce tow prepregs from the materials and under the production conditions set forth in Table 1 for Example 5, Example 6, Example 7, Example 8, Example 9, and Example 10. The results of the runs are shown in Table 1.

All the resin impregnation ratios were greater than 90%. The results of the unwinding tests conducted at room temperature were good.

### Example 11

The prepreg was formed using a system set up according to FIG. 1. One hundred twenty carbon fibers TRH50 60K (Mitsubishi Rayon Co., Ltd.) by adjoining each other was used as a starting material. Parallel rollers 3 and 4 as shown in FIG. ______ were heated to 77° C. HMT301H resin (Newport Adhesives and Composites Corporation) was also heated to the same temperature.

After maintaining the viscosity of the resin at 71.5 poise, the resin was introduced into the gap between the impregnation rollers (roller 3 and roller 4). The rollers 6 in FIG. 1 were adjusted to 95° C. After passing through zone32 in FIG. 1, these fibers were put with the resin film that each films were coated with a resin of 45 gsm (Newport Adhesives and Composites, INC) from the upper and lower sides. And these fibers were formed in a sheet by being pressurized with heated roller which was temperature was 95° C. This sheet was wound on a 10 inches cardboard core after cooling, A unidirectional prepreg tape of 600 grams/m² fiber area weight (FAW), and Resin content of 33.4 weight % was produced. The results of the Example 11 run are shown in Table 1. The resin content of the unidirectional prepreg thus obtained was 33.4%. (The resin content of the tow prepreg at zone 32 in FIG. 1 was 26.2%.). The resin impregnation ratio was 96.4% based on the photographic observation of the cross-section of the tow prepreg. The results of the tackiness, unwinding, and 90° tensile strength tests were good as shown in Table 1.

### Example 12

The prepreg was formed using a system set up according to FIG. 1. One hundred twenty carbon fibers TRH50 60K (Mitsubishi Rayon Co., Ltd.) by adjoining each other was used as a starting material. Parallel rollers 3 and 4 as shown in FIG. 1 were heated to 77° C. HMT301H resin (Newport Adhesives and Composites Corporation) was also heated to the same temperature.

After maintaining the viscosity of the resin at 71.5 poise, the resin was introduced into the gap between the impregnation rollers (roller 3 and roller 4). The rollers 6 in FIG. 1 were adjusted to 95° C. After passing through zone 32 in FIG. 1, these fibers were put with the release papers from the upper and lower sides. And these fibers were formed in a sheet by being pressurized with heated roller which was temperature was 95° C. This sheet was winded by 10 inches paper core after cooling, we could product the unidirectional prepreg tape which prepreg had a fiber area weight (FAW) of 605.1 grams/m². Resin content was 25.5 weight %.

The results of the Example 12 run are shown in Table 1. The resin content of the unidirectional prepreg thus obtained was 25.5%. The resin impregnation ratio was 95.5% based on the photographic observation of the cross-section of the tow prepreg. The results of the tackiness, unwinding, and 90° tensile strength tests were good as shown in Table 1.

### Example 13

The prepreg was formed using a system set up according to FIG. 1. One hundred ninety carbon fibers TRH50 18K manufactured by Mitsubishi Rayon Co., Ltd. by adjoining each other was used as a starting material. Parallel rollers 3 and 4 as shown in FIG. 1 were heated to 77° C. HMT301H resin manufactured by Newport Adhesives and Composites Corporation was also heated to the same temperature.

After maintaining the viscosity of the resin at 71.5 poise, the resin was introduced into the gap between the impregnation rollers (roller 3 and roller 4). The rollers 6 in FIG. 1 were adjusted to 95° C. After passing through zone 32 in FIG. 1, these fibers were put with the resin film that each films were coated resin of 23 gsm manufactured by Newport Adhesives and Composites, INC from the upper and lower sides. And these fibers were formed in a sheet by being pressurized with heated roller which was temperature was 95° C. This sheet was winded by 10 inches paper core after cooling, we could product the unidirectional prepreg tape which prepreg had a FAW of 298.0 grams/m², a Resin content was 37.0 weight %.

The results of the Example 13 run are shown in Table 1. The resin content of the unidirectional prepreg thus obtained was 37.0%. (The resin content of the tow prepreg at zone 32 in FIG. 1. was 27.8%.) The resin impregnation ratio was 98.1% based on the photographic observation of the cross-section of the tow prepreg. The results of the tackiness, unwinding, and 90° tensile strength tests were good as shown in Table 1.

### Example 14

### Comparison 1

Several experimental runs were conducted similar to Example 1 to compare the results when certain conditions are adjusted.

In first comparison (referred to as Example 11), the prepreg was formed using a system and method similar to that of Example 1 except that the resin was SC301H manufactured by Newport Adhesives and Composites Corporation, the temperature of the rollers 7 was 45° C., and the temperature of the rollers 3 and 4 was 96.1° C.

The results of the Comparison 1 run are shown in Table 2. In the course of producing the tow prepreg, an extremely large amount of fuzz was generated at a time when a carbon fiber passed through the parallel rollers 7 and 10. The carbon fiber was eventually broken by the fluffs and continuous production had to be abandoned.

### Example 15

### Comparison 2

In Comparison 2 the conditions were similar to those of Example 1 except that a thermosetting resin was prepared by mixing 5 weight % of Dyhard 100S (Degussa Corporation) with Epon 828 (Hexion Corporation), the temperature between the parallel rollers 3 and 4 was 85° C. (viscosity of the resin was 0.37 poise), and the temperature of the rollers 7 and 10 was 96.1° C.

The results of the Comparison 2 run are shown in Table 2. During production of the tow prepreg, the resin leaked out in a downward direction from the gap between the parallel rollers (rollers 3 and 4). Hence, continuous production had to be abandoned.

### Example 16

### Comparison 3

In Comparison 3, it was attempted to prepare a tow prepreg having a resin content of 35% using a generally-used, conventional filament winding apparatus. TRH50 18K manufactured by Mitsubishi Rayon Co., Ltd. was passed through a resin tank containing a thermosetting resin formed by mixing Epon 828 (Hexion Corporation). The thermosetting resin was mixed with acid anhydride NH-2200 in the same weight ratio as Comparison 2. Excess resin was scraped off by allowing the resin to abrade with three fixed rollers of a 1-inch diameter. The resulting tow prepreg was then wound on a winder.

The resin content of the resulting tow prepreg fluctuated in the range of 35% to 45%. Thus, it was not possible to control the resin content in this process.

In the taken-up tow prepreg, resin on the inner side was squeezed out to the outer side of a bobbin by its winding tension. As a result, the resin content was about 30% on the inner side of the bobbin and 45 to 50% on the outer side of the bobbin. Thus, we were unable to obtain a homogenous tow prepreg.

As a result of the unwinding test, it was found that the tow prepreg was very sticky in terms of tackiness. Nonetheless, it was possible to unwind the material. The 90° tensile strength was 54 MPa, which was lower than the prepreg produced in Examples 1-10 but generally within a normal range.

The full results of Comparison 3 run are shown in Table 2.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

TABLE 1

| | | Example Number | | | | | | |
|---|---|---|---|---|---|---|---|---|
| | | Ex-1 | Ex-2 | Ex-3 | Ex-4 | Ex-5 | Ex-6 | Ex-7 |
| Fiber | | HR40 | HR40 | HR40 | TRH50 | TRH50 | TRH50 | MR60H |
| | | 12K | 12K | 12K | 60K | 18K | 18K | 24K |
| Resin type | (—) | NB317 | NB317 | NB317 | SC301 | SC301 | SC301H | HMT301 |
| Resin Viscocity at 40 C. | (poise) | 832 | 850 | 850 | 421 | 458 | 4025 | 437 |
| Viscocity | (poise) | 16.1 | 18.6 | 18.6 | 14.7 | 18.7 | 121.1 | 15.7 |
| Temperature of resin using | (° C.) | 79.4 | 77.7 | 77.7 | 75 | 73.9 | 71 | 76.7 |
| The clearance between rolls | (mil) | 3 | 4 | 5.3 | 20 | 8 | 5.5 | 4 |
| Roll 3& Roll 4 temperature | (° C.) | 80 | 78 | 78 | 75 | 74 | 71 | 77 |
| Heated idler roll | (° C.) | 70 | 98 | 97 | 93 | 93 | 88 | 107 |
| Speed | (feet/min) | 30 | 35 | 45 | 35 | 35 | 35 | 35 |
| Spools number | | 4 | 4 | 4 | 4 | 8 | 8 | 5 |

Result

| | | | | | | | | |
|---|---|---|---|---|---|---|---|---|
| Resin content | (%) | 31.5 | 35.9 | 32.1 | 30.2 | 36.3 | 36.4 | 36.2 |
| Impregnation | (%) | 98 | 98.3 | 97.5 | 95.8 | 97.8 | 99.4 | 98.9 |
| Unwind-able | — | Excellent | Excellent | Excellent | Excellent | Excellent | Excellent | Excellent |
| Tack feeling | — | Good | Good | Good | Good | Good | Good | Excellent |
| 90 Tension strenght | (Mpa) | 65 | 67 | 68 | 70 | 78 | 79 | 78 |

| | | Example Number | | | | | |
|---|---|---|---|---|---|---|---|
| | | Ex-8 | Ex-9 | Ex-10 | Ex-11 | Ex-12 | Ex-13 |
| Fiber | | MR60H | MR60H | MR60H | TRH50 | TRH50 | TRH50 |
| | | 24K | 24K | 24K | 60K | 60K | 18K |
| Resin type | (—) | SC301 | SC301H | SC301H | HMT301H | HMT301H | HMT301H |
| Resin Viscocity at 40 C. | (poise) | 3256 | 3256 | 3256 | 4137 | 4137 | 4137 |
| Viscocity | (poise) | 73.7 | 73.7 | 69.7 | 71.5 | 71.5 | 71.5 |
| Temperature of resin using | (° C.) | 76.7 | 76.7 | 77.2 | 77.0 | 77.0 | 77.0 |
| The clearance between rolls | (mil) | 6.3 | 5 | 5 | 28 | 30 | 10 |
| Roll 3& Roll 4 temperature | (° C.) | 77 | 77 | 78 | 77 | 77 | 77 |
| Heated idler roll | (° C.) | 105 | 88 | 90 | 95 | 95 | 95 |
| Speed | (feet/min) | 50 | 35 | 39 | 20 | 15 | 20 |
| Spools number | | 9 | 12 | 12 | 120 | 120 | 190 |
| Result | | | | | | | |
| Resin content | (%) | 32.9 | 33 | 34.5 | 26.2 | 25.5 | 27.8 |
| Impregnation | (%) | 98.6 | 99.1 | 98.5 | 96.4 | 95.5 | 98.1 |
| Unwind-able | — | Excellent | Excellent | Excellent | Excellent | Excellent | Excellent |
| Tack feeling | — | Excellent | Excellent | Excellent | Excellent | Excellent | Excellent |
| 90 Tension strenght | (Mpa) | 75 | 76 | 74 | 75 | 77 | 74 |

TABLE 2

| Example Number | | Ex-14 | Ex-15 | Ex-16 |
|---|---|---|---|---|
| Comparison Number | | comparison-1 | comparison-2 | comparison-3 |
| Fiber | | HR40 | HR40 | TR50S |
| | | 12K | 12K | 12K |
| Resin type | (—) | SC301H | Ep828 | Ep828/HN-2200 |
| Resin Viscocity at 40 C. | (poise) | 32514 | 18 | 10 |
| Viscocity | (poise) | 5200 | 0.37 | — |
| Temperature of resin using | (° C.) | 45 | 85 | — |
| The clearance between rolls | (mil) | 3 | 4 | — |
| Roll 3, Roll 4temperature | (° C.) | 45 | 85 | — |
| Heated idler roll | (° C.) | 99 | 100 | — |
| Speed | eet/mi | 30 | 30 | — |
| Spools number | | 4 | 4 | — |

Result

| | | | | |
|---|---|---|---|---|
| Resin content | (%) | — | — | — |
| Impregnation | (%) | — | — | 75 |
| Unwinding | — | — | — | good |
| Tank feeling | — | | | Top heavy |
| 90 Tension strenght | (Mpa) | | | 54 |

What is claimed is:

1. A method for manufacturing a resin impregnated fiber, comprising:
applying flowable resin to a gap defined by a surface of each of two or more rollers, wherein the resin is supplied to the gap from a reservoir formed from said two or more rollers; and
passing at least one continuous fiber through the gap thereby contacting the fiber with the flowable resin, wherein at least one of said two or more rollers rotate in the direction of the passing of the fiber, such that during the passing of the fiber through the said fiber is impregnated with said flowable resin.

2. The method of claim 1, wherein the fiber is a member of a plurality of fibers forming a tow prepreg.

3. The method of claim 1, wherein the impregnating is performed under conditions sufficient to prevent the resin from catalyzing.

4. The method of claim 1, wherein the impregnating is performed under conditions sufficient to prevent the impregnated fiber from plasticizing.

5. The method of claim 1, wherein the viscosity of the flowable resin applied to the fiber is controlled within a range of about 0.5 poise to about 1000 poise at the impregnation process temperature.

6. The method of claim 1, wherein the resin prior to impregnation has a viscosity controlled between about 100 poise and about 300,000 poise at about 40° Celsius.

7. The method of claim 1, wherein the two or more rollers cause the resin to at least partially impregnate the fiber.

8. The method of claim 1, further comprising: after impregnating the fiber, applying heat directly or indirectly to the resin-impregnated fiber to increase impregnation of the resin in the fiber.

9. The method of claim 1, further comprising, following a member selected from the impregnation, the heating and a combination thereof, cooling the impregnated fiber.

10. The method of claim 1, further comprising after the cooling, winding the fiber around a bobbin without a release liner.

11. The method of claim 1, wherein the resulting fiber has a resin impregnation ratio of at least 90%.

12. The method of claim 1, further comprising passing a plurality of individual continuous reinforcement fibers between the rollers.

13. The method of claim 1, wherein, prior to the impregnating, the reinforcement fibers are in a tow shape.

14. The method of claim 12, wherein the tow is formed of loosely-coupled carbon fibers.

15. The method of claim 1, wherein the resin is applied using two rollers, the ratio of circumferential velocity of the first roller relative to the second roller being between about 0.7 and about 1.2.

16. The method of claim 1, wherein the resin is applied using two rollers, a ratio of circumferential velocity of the second roller relative to the first roller being between 0 and about 0.5.

17. The method of claim 1, wherein the thickness of the resin applied to the gap between the rollers is in a range selected from the group consisting of between about 3 mm and about 12 mm, between about 3 mm and about 8 mm, and between about 3 mm and about 4 mm.

18. The method of claim 1, wherein the fiber, prior to impregnation, has a tensile modulus of 2500 MPa or more.

19. The method of claim 1, wherein the fiber is a member selected from the group consisting of carbon fiber, graphite fiber, glass fiber, aramid fiber, and combinations of the same.

20. The method of claim 1, wherein the resin is a member selected from the group consisting of epoxy resin, bt-resin, phenolic resin, bismaleimide resin, bismaleimide triazine resin, isocyanate resin, vinylester resin, and combinations of the same.

21. A member selected from a fiber and a tow prepreg which is prepared according to the method of claim 1.

22. A system for manufacturing a resin impregnated fiber, comprising:
a first roller having a first cylindrical roller surface, and a second roller having a second cylindrical roller surface, wherein the first and second cylindrical roller surfaces define a flowable resin reservoir and further define a gap between said surfaces for receiving at least one continuous fiber therethrough, and through which the flowable resin is capable of flowing,
the two or more rollers are configured to coat the at least one continuous fiber with the flowable resin thereby impregnating the fiber with the resin as the fiber and the resin pass through the gap, the two or more rollers positioned essentially in parallel, and rotating in the direction of travel of the fiber through the gap.

23. The system according to claim 22, further comprising:
a heater for heating the reinforcement fiber in the vicinity of the two or more rollers, wherein the heater is configured to maintain the resin-impregnated fiber below a predetermined reaction starting temperature.

24. The system of claim 22, wherein the first roller and the second flatten the at least one fiber while coating the fiber with resin.

25. The system of claim 22, wherein a at least a portion of the first cylindrical surface and the second cylindrival surface is maintained at a predetermined temperature between about 70 degrees Celsius and about 80 degrees Celsius.

26. The system of claim 22, further comprising one or more chilling rollers downstream from the first and second roller for reducing the temperature of the coated fiber, the one or more chilling rollers maintained at a predetermined temperature of about 15 degrees Celsius.

27. The system of claim 22, further comprising:
a conveyer for delivering the reinforcement fiber to the first and second roller;
a dispenser for dispensing the flowable resin to the first and second roller; and
a winder roller for winding up the fiber prior to curing.

28. A system for forming a resin impregnated fiber, comprising:
the system for forming a tow prepreg of claim 22; and
means for curing the fiber, wherein the system for forming the impregnated fiber and the curing means are distinct.

29. The system of claim 27, wherein the conveyor conveys the fiber between about 30 feet/minute and about 35 feet/minute.

30. The system of claim 22, wherein the resulting fiber has a weight per unit area (FAW) of at least 550 grams/m².

31. The system of claim 22, wherein the resulting fiber is composed of less than about 35% by weight resin.

32. A method of forming a composite film structure comprising:
providing a continuous reinforcement fiber; and
impregnating the fiber with a flowable resin, the impregnating comprising:
laying the flowable adhesive resin on a surface of the fiber;
applying pressure to the resin and the fiber; and
heating the resin and the fiber to a predetermined temperature to cause at least partial impregnation of the fiber with the resin,
wherein the predetermined temperature is below a reaction starting temperature of the resin impregnated in the fiber.

33. The method according to claim 32, wherein the impregnating is performed under conditions sufficient to cause at least partial impregnation of the fiber by the resin without significantly catalyzing the impregnated resin.

34. A tow prepreg comprising:
a tow material formed of a plurality of reinforcement fibers, the reinforcement fibers being a member selected from the group consisting of carbon fiber, graphite fiber, glass fiber, aramid fiber, and combinations of the same; and
a resin impregnated in the tow material, resin being a member selected from the group consisting of epoxy resin, bt-resin, phenolic resin, bismaleimide resin, bismaleimide triazine resin, isocyanate resin, vinylester resin, and combinations of the same;
wherein the prepreg has a fiber weight per unit area (FAW) of more than about 600 grams/m².

35. The two prepreg according to claim 34, wherein the impregnation ratio of the fiber with the resin is at least 90%.
